(19) United States
(12) Patent Application Publication
(10) Pub. No.: US 2019/0086606 A1
(43) Pub. Date: Mar. 21, 2019

(54) LIGHT GUIDE PLATE, BACKLIGHT MODULE ASSEMBLY AND LIQUID CRYSTAL DISPLAY DEVICE

(71) Applicants: BOE TECHNOLOGY GROUP CO., LTD., Beijing (CN); Beijing BOE Optoelectronics Technology Co., Ltd., Beijing (CN)

(72) Inventors: Dake WANG, Beijing (CN); Zheng WANG, Beijing (CN); Xiuyun CHEN, Beijing (CN)

(21) Appl. No.: 15/757,726

(22) PCT Filed: Sep. 25, 2017
(86) PCT No.: PCT/CN2017/103114

§ 371 Date: Mar. 6, 2018

(30) Foreign Application Priority Data
Feb. 8, 2017 (CN) 201710069267.X

(51) Int. Cl. F21V 8/00; G02F 1/1333

(52) U.S. Cl. CPC G02B 6/0088; G02F 2001/133314; G02B 6/0095; G02F 1/133308

(57) ABSTRACT

The present disclosure provides a light guide plate, a backlight module assembly and a liquid crystal display device, which are of a liquid crystal display technical field. The light guide plate includes a plate body and a retaining wall. One surface of the plate body is a light-emitting surface of the light guide plate, and the retaining wall is an annular structure arranged along an edge of the plate body, and protrudes to the light-emitting surface. The plate body and the retaining wall together form a groove for receiving a display panel and an optical film. The present disclosure solves a problem of poor polarizer as a result that the plastic frame shrinks and presses the display panel at a low temperature.

### CROSS REFERENCE TO RELATED APPLICATIONS

This disclosure is based on International Application No. PCT/CN2017/103114, filed on Sep. 25, 2017, which is based upon and claims priority to Chinese Patent Application No. 201710069267.X, filed on Feb. 8, 2017, which is incorporated herein by reference in its entirety.

### TECHNICAL FIELD

The present disclosure relates to a liquid crystal display technical field, particularly to a light guide plate, a backlight module assembly and a liquid display device.

### BACKGROUND

Liquid crystal display devices, due to advantages of thin body, power conservation and no radiation, are widely used in various fields.

The liquid crystal display mainly includes a display panel and a backlight module assembly. An upper polarizer and a lower polarizer are adhered and fixed to the upper and lower portions of the display panel. The backlight module assembly includes a light guide plate, a plastic frame and a back plate. The light guide plate and the plastic frame are arranged within the back plate. The plastic frame is located between the light guide plate and the back plate and arranged around the light guide plate. A protruding structure that protrudes to the middle of the light guide plate is provided on the inner side wall of the plastic frame. The protruding structure and the inner side wall of the plastic frame form a groove for receiving the display panel. The display panel is fixed within the groove and is located on one side of the light-emitting surface of the light guide plate.

It should be noted that the Background portion contains the contents which are merely used for reinforcing understanding of the background technology of the present disclosure, and thus may include information that does not constitute the prior art as already known by an ordinary person skilled in the art.

### SUMMARY

According to one aspect of the present disclosure, the present disclosure provides a light guide plate. The light guide plate includes a plate body that has one surface that is a light-emitting surface of the light guide plate; and a retaining wall, which is an annular structure arranged along an edge of the plate body, and protrudes to the light-emitting surface, the plate body and the retaining wall together form a groove for receiving a display panel and an optical film.

According to another aspect of the present disclosure, the present disclosure provides a backlight module assembly. The backlight module assembly includes a light guide plate, an optical film, a back plate and a light-emitting unit. The light guide plate has a light incidence surface and a light-emitting surface, wherein the light guide plate comprises a plate body and a retaining wall, one surface of the plate body is a light-emitting surface of the light guide plate, the retaining wall is an annular structure arranged on an edge of the plate body, and protrudes to the light-emitting surface; the plate body and the retaining wall forms a groove for receiving a display panel and an optical film, and the optical film is provided within the groove and attached to the light-emitting surface; the light guide plate and the light-emitting unit are provided on the back plate, and the light-emitting unit is provided at the light incidence surface of the light guide plate.

According to another aspect of the present disclosure, the present disclosure provides a liquid crystal display device. The liquid crystal display panel includes a display panel and the backlight module assembly according to the present disclosure, and the display panel is arranged within the groove of the light guide plate.

It is should be understood that both the foregoing general description and the following detailed description are merely exemplary and explanatory but not used for limiting the present disclosure.

Summary of various implementations or examples of the techniques described in this disclosure are provided rather than contains all scope of the disclosed technology or complete disclosure of all the technical features.

### BRIEF DESCRIPTION OF THE DRAWINGS

Hereinafter, the drawings used for illustrating the embodiments will be introduced briefly in order to describe the technical solutions in the embodiment of the present disclosure clearly. Obviously, the accompanying drawings in the following description show merely some embodiments of the present disclosure. For those skilled in the art, other drawings also can be obtained based on these drawings without any creative work.

FIG. 1A is a structural schematic view of a light guide plate according to an embodiment of the present disclosure;

FIG. 1B is a cross-sectional schematic view taken along a line A-A of the light guide plate as shown in FIG. 1A;

FIG. 1C is a cross-sectional schematic view taken along a line B-B of the light guide plate as shown in FIG. 1A;

FIG. 2A is a structural schematic view of a further light guide plate according to the embodiment of the present disclosure;

FIG. 2B is a cross-sectional schematic view taken along a line A-A of the light guide plate as shown in FIG. 2A;

FIG. 2C is a cross-sectional schematic view taken along a line B-B of the light guide plate as shown in FIG. 2A;

FIG. 3A is a structural schematic view of a backlight module assembly according to the embodiment of the present disclosure;

FIG. 3B is a cross-sectional schematic view taken along a line A-A of the backlight module assembly as shown in FIG. 3A;

FIG. 3C is a cross-sectional schematic view taken along a line B-B of the backlight module assembly as shown in FIG. 3A;

FIG. 4A is a structural schematic view of a further backlight module assembly according to the embodiment of the present disclosure;

FIG. 4B is a cross-sectional schematic view taken along a line A-A of the backlight module assembly as shown in FIG. 4A;

FIG. 4C is a cross-sectional schematic view taken along a line B-B of the backlight module assembly as shown in FIG. 4A; and

FIG. 5 is a structural schematic view of a liquid crystal display device according to the embodiment of the present disclosure.

### DETAILED DESCRIPTION

The object, technical solutions and advantages of the present disclosure are apparent from the following detailed description taken in conjunction with the accompanying drawings.

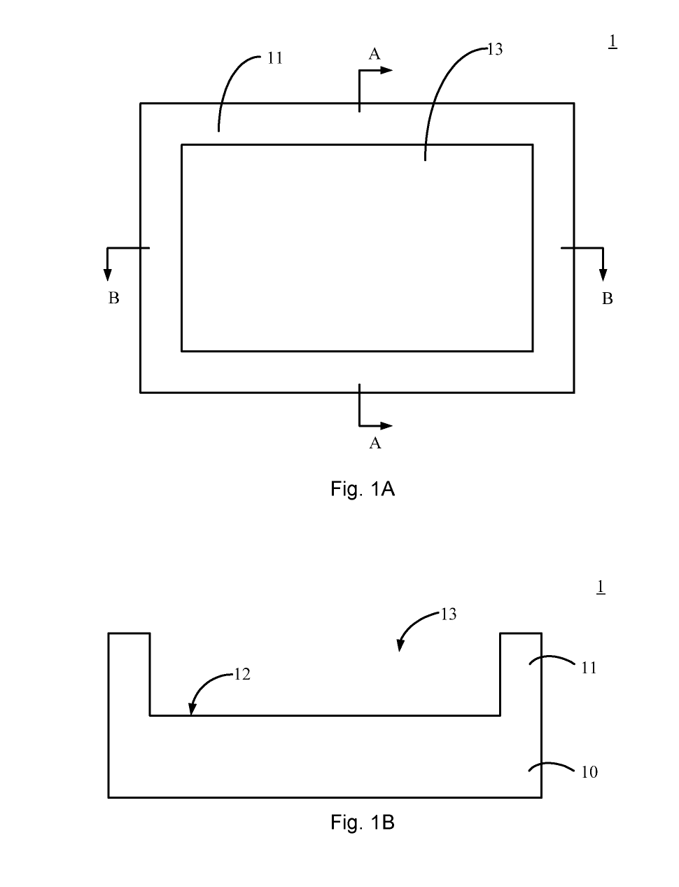

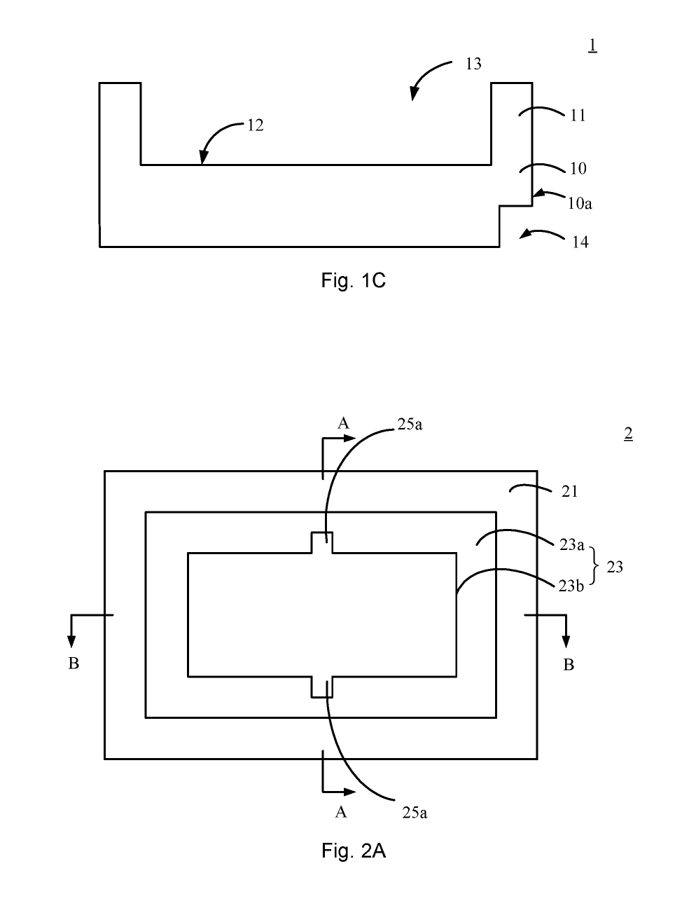

FIG. 1A is a structural schematic view of a light guide plate according to an embodiment of the present disclosure. FIG. 1B and FIG. 1C are a cross-sectional schematic view taken along a line A-A and a cross-sectional schematic view taken along a line B-B of the light guide plate as shown in FIG. 1A, respectively. As shown in FIG. 1A-FIG. 1C, a light guide plate 1 includes a plate body 10 and a retaining wall 11. One surface of the plate body 10 is a light-emitting surface 12 of the light guide plate 1. The retaining wall 11 is arranged to protrude from the light-emitting surface 12, and is an annular structure arranged along the edge of the plate body 10 (as shown in FIG. 1A). The plate body 10 and the retaining wall 11 form a groove 13 for receiving a display panel and an optical film.

In the embodiment of the present disclosure, a retaining wall having an annular structure is arranged on the light-emitting surface of the light guide plate. The retaining wall and the plate body form a groove for receiving the display panel and the optical film. The display panel and the optical film can be fixedly supported by the light guide plate, such that the display panel can be mounted without using other structures, for example, a plastic frame, so as to avoid a problem of poor polarizer caused by squeezing the display panel due to contraction of the plastic frame at a low temperature.

Optionally, the plate body 10 and the retaining wall 11 are one-piece structure, and may be manufactured by an injection molding process. The light guide plate 1 may be made of organic materials, and also made of inorganic materials, such as glasses, which is not limited in the present disclosure.

In one embodiment, as shown in FIG. 1C, light-emitting unit mounting slot 14 for receiving light-emitting unit is provided on a side wall 10a of the plate body 10. The light-emitting unit mounting slot 14 is opened on the side wall 10a of the plate body 10, and the light-emitting unit is arranged within the light-emitting unit mounting slot 14 to be embedded in the plate body 10, such that it is helpful to achieve a narrow frame.

It should be noted that in the embodiment as shown in FIG. 1C, the light-emitting unit mounting slot 14 is arranged on the side wall 10a of the plate body 10, herein light enters from the side wall 10a of the plate body 10 of the light guide plate. A light incidence mode of the display panel is a side-entered single-side light incidence mode, wherein the side-entered light incidence mode further includes a double-side light incidence mode, and both the single-side light incidence mode and the double-side light incidence mode may employ a long-edge light incidence or a short-edge light incidence. In other embodiments, the light-emitting unit mounting slot 14 may also be arranged according to the light incidence mode of the display panel, for example, the light-emitting unit mounting slot 14 may be arranged on the two side walls of the plate body 10 of the light guide plate when the light incidence mode of the display panel is the double-side light incidence. Furthermore, the light-emitting unit mounting slot 14 may be arranged on the side wall of the long edge of the plate body 10 of the light guide plate when the light incidence mode of the display panel is the long-edge light incidence. The light-emitting unit mounting slot may be arranged on the side wall of the short edge of the plate body 10 of the light guide plate when the light incidence mode of the display panel is the short-edge light incidence mode. The present disclosure is not limited thereto.

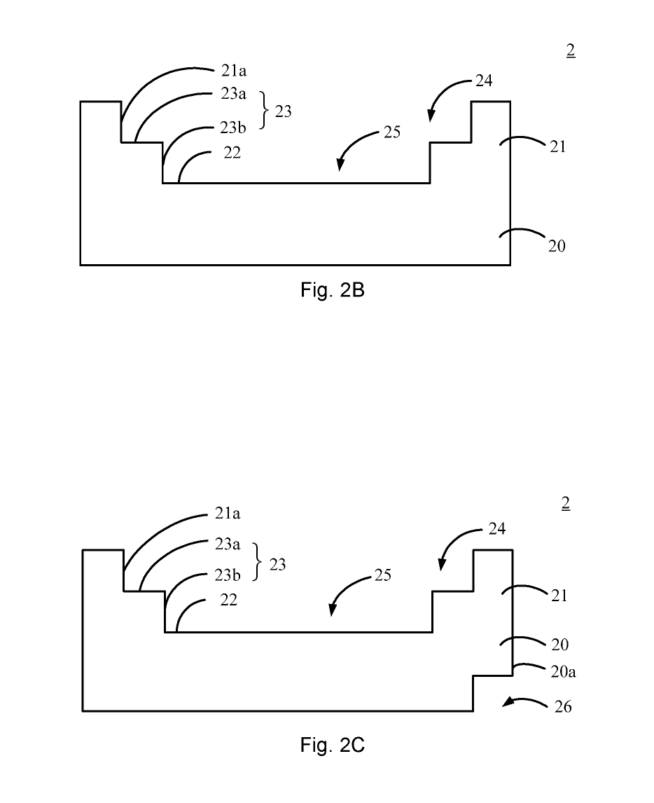

FIG. 2A is a structural schematic view of another light guide plate according to the embodiment of the present disclosure. FIG. 2B and FIG. 2C are a cross-sectional schematic view taken along a line A-A and a cross-sectional schematic view taken along a line B-B of the light guide plate as shown in FIG. 2A, respectively. As shown in FIG. 2A-FIG. 2C, a light guide plate 2 includes a plate body 20 and a retaining wall 21. One surface of the plate body 20 is a light-emitting surface 22 of the light guide plate 2. The retaining wall 21 is arranged to protrude from the light-emitting surface 22, and is an annular structure arranged along the edge of the plate body 20 (as shown in FIG. 2A).

In one embodiment, an annular stepped part 23 extending from the light-emitting surface 22 is provided on the inner wall 21a of the retaining wall 21. The stepped part 23 and the retaining wall 21 form a first groove 24 for receiving the display panel, and the stepped part 23 and the plate body 20 form a second groove 25 for receiving an optical film.

The first groove for receiving the display panel and the second groove for receiving the optical film are formed by arranging the stepped part. The display panel and the optical film are respectively arranged in the two grooves to be fixed more stably, and thereby being used in a vehicle-mounted device that is in a harsh traveling environment and has a higher request for stability of the display panel. The display panel and the optical film may be fixedly supported by the light guide plate, such that the display panel can be mounted without using the plastic frame so as to avoid a problem of poor polarizer caused by squeezing the display panel due to contraction of the plastic frame at a low temperature.

Particularly, as shown in FIG. 2B and FIG. 2C, the stepped part 23 has a top surface 23a and a side surface 23b, wherein the top surface 23a of the stepped part and the inner wall 21a of the retaining wall 21 form the first groove 24 for receiving the display panel, and the side surface 23b of the stepped part and the plate body 20 form the second groove 25 for receiving the optical film.

Optionally, the plate body 20, the retaining wall 21 and the stepped part 23 are one-piece structure, and may be manufactured by an injection molding process. The light guide plate 2 may be made of organic materials, and also made of inorganic materials, such as glasses, which is not limited in the present disclosure.

In one embodiment, as shown in FIG. 2A, a limiting slot 25a for fixing the optical film is opened on the two side walls opposite to each other (i.e., the stepped part 23) of the second groove 25. The limiting slot 25a can fix the optical film on the two side walls opposite to each other of the second groove 25, and also can take a function of preventing inversion. In a practical use, the limiting slot 25a can be arranged to be one or more according to the actual situations.

In one embodiment, as shown in FIG. 2C, a light-emitting unit mounting slot 26 for receiving the light-emitting unit is provided on the side wall 20a of the plate body 20. The light-emitting unit mounting slot 26 is opened on the side wall 20a of the plate body 20, and the light-emitting unit is arranged within the light-emitting unit mounting slot 26 to be embedded in the plate body 20, such that it is helpful to achieve a narrow frame.

It should be noted that in the embodiment as shown in FIG. 2C, the light-emitting unit mounting slot 26 is arranged on the side wall 20a of the plate body 20, herein light enters from the side wall 20a of the plate body 20 of the light guide plate. A light incidence mode of the display panel is a side-entered single-side light incidence mode, wherein the side-entered light incidence mode further includes a double-side light incidence mode, and both the single-side light incidence mode and the double-side light incidence mode may employ a long-edge light incidence or a short-edge light incidence. In other embodiments, the light-emitting unit mounting slot 26 may also be arranged according to the light incidence mode of the display panel, for example, the light-emitting unit mounting slot 26 may be arranged on the two side walls of the plate body 20 of the light guide plate when the light incidence mode of the display panel is the double-side light incidence. Furthermore, the light-emitting unit mounting slot 26 may be arranged on the side wall of the long edge of the plate body 20 of the light guide plate when the light incidence mode of the display panel is the long-edge light incidence. The light-emitting unit mounting slot may be arranged on the side wall of the short edge of the plate body 20 of the light guide plate when the light incidence mode of the display panel is the short-edge light incidence mode. The present disclosure is not limited thereto.

It should be noted that the limiting slot 25a on the plate body 20 of the light guide plate may be arranged on one side of the light guide plate without the light-emitting unit mounting slot 26.

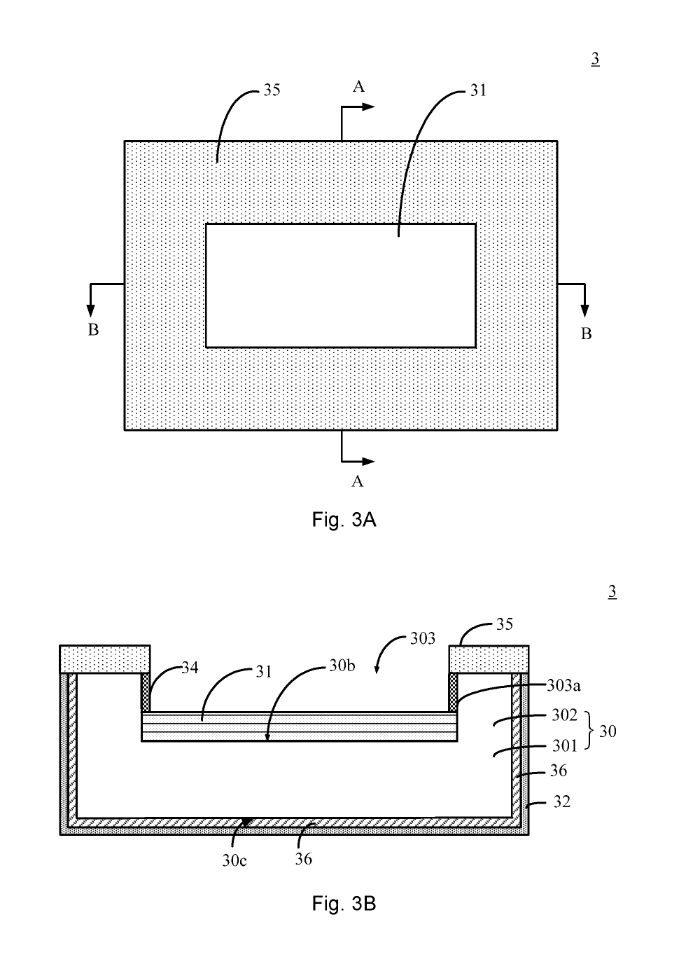

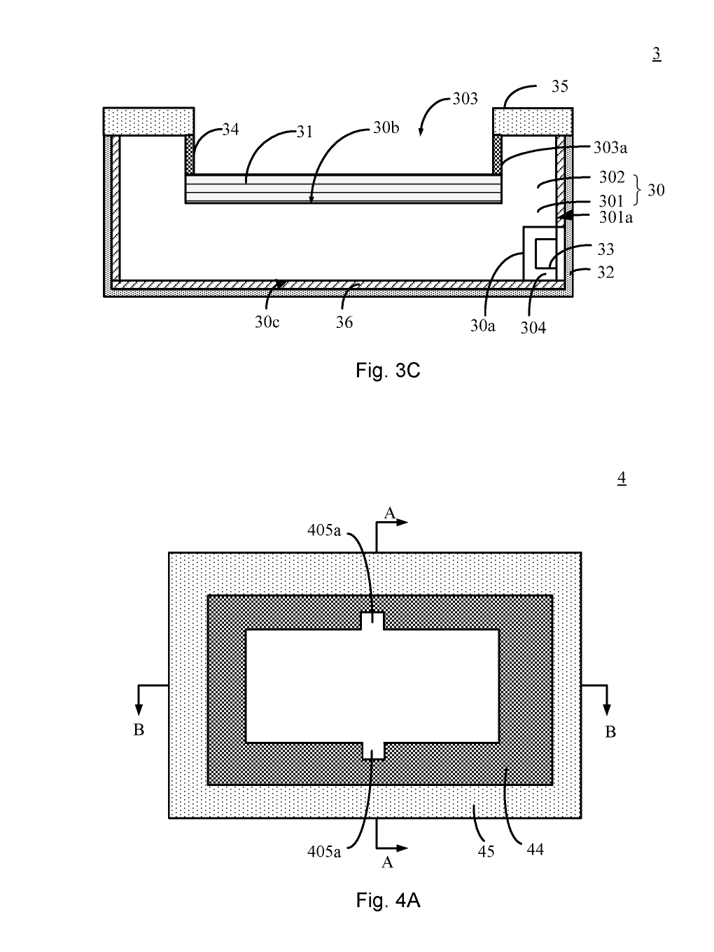

FIG. 3A is a structural schematic view of a backlight module assembly according to the embodiment of the present disclosure. FIG. 3B and FIG. 3C are a cross-sectional schematic view taken along a line A-A and a cross-sectional schematic view taken along a line B-B of the backlight module assembly as shown in FIG. 3A, respectively. As shown in FIG. 3A-FIG. 3C, backlight module assembly 3 includes a light guide plate 30, an optical film 31, a back plate 32 and a light-emitting unit 33. The light guide plate 30 has a light incidence surface 30a and a light-emitting surface 30b. The light guide plate 30 includes a plate body 301 and a retaining wall 302. One side surface of the plate body 301 is the light-emitting surface 30b of the light guide plate 30. The retaining wall 302 is arranged to protrude to the light-emitting surface 30b, and is the annular structure arranged along the edge of the plate body 301. The plate body 301 and the retaining wall 302 form a groove 303 for receiving the display panel and the optical film 31. The optical film 31 is provided within the groove 303 and attached to the light-emitting surface 30b. The light guide plate 30 and the light-emitting unit 33 are arranged on the back plate 32. The light-emitting unit 33 is arranged at the light incidence surface 30a of the light guide plate 30.

In the backlight module assembly as provided by the embodiment of the present disclosure, the light-emitting surface of the light guide plate is arranged to be a retaining wall presented in an annular structure. The retaining wall and the plate body form the groove for receiving the display panel and the optical film. The display panel and the optical film may be fixedly supported by the light guide plate, such that the display panel can be mounted without using the plastic frame, so as to avoid a problem of poor polarizer caused by squeezing the display panel due to contraction of the plastic frame at a low temperature.

Optionally, the plate body 301 and the retaining wall 302 are the one-piece structure, and may be manufactured by the injection molding process. The light guide plate 30 may be made of organic materials, and also made of inorganic materials, such as glasses, which is not limited in the present disclosure.

Optionally, the optical film 31 includes but not limits to a brightness enhancement sheet and a brightness diffusion sheet, which can be arranged according to the actual situations. The present disclosure does not limit thereto.

In one embodiment, a light-emitting unit mounting slot 304 for receiving a light-emitting unit 33 is provided on the side wall 301a of the plate body 301. The light-emitting unit mounting slot 304 is opened on the side wall 301a of the plate body 301, and the light-emitting unit 33 is arranged within the light-emitting unit mounting slot 304 to be embedded in the plate body 301, such that it is helpful to achieve the narrow frame.

It should be noted that as shown in FIG. 3C, the light-emitting unit mounting slot 304 is arranged on the side wall 301a of the plate body 301 of the light guide plate, herein light enters from the side wall 301a of the plate body 301 of the light guide plate. A light incidence mode of the display panel is a side-entered single-side light incidence mode, wherein the side-entered light incidence mode further includes a double-side light incidence mode, and both the single-side light incidence mode and the double-side light incidence mode may employ a long-edge light incidence or a short-edge light incidence. In other embodiments, the light-emitting unit mounting slot 304 may also be arranged according to the light incidence mode of the display panel, for example, the light-emitting unit mounting slot 304 may be arranged on the two side walls of the plate body 301 of the light guide plate when the light incidence mode of the display panel is the double-side light incidence. Furthermore, the light-emitting unit mounting slot 304 may be arranged on the side wall of the long edge of the plate body 301 of the light guide plate when the light incidence mode of the display panel is the long-edge light incidence. The light-emitting unit mounting slot 304 may be arranged on the side wall of the short edge of the plate body 301 of the light guide plate when the light incidence mode of the display panel is the short-edge light incidence mode. The present disclosure is not limited thereto.

In one embodiment, as shown in FIG. 3B and FIG. 3C, an elastic light absorbing layer 34 is further provided on the inner wall 303a of the groove 303.

Particularly, the optical film 31 is provided within the groove 303 and attached to the light-emitting surface 30b. The elastic light absorbing layer 34 is provided on portion of the inner wall 303a of the groove 303, which is not in contact with the optical film 31. The elastic light absorbing layer 34 is provided within the groove 303 and can be used to limit and fix the display panel and the optical film 31, and the elastic light absorbing layer 34 may prevent the display panel from directly contacting with the light guide plate 30 to be scratched, and thereby playing a buffering effect, and also absorb light to prevent the light from leaking from the periphery to result in bright lines on the display panel.

Optionally, the elastic light absorbing layer 34 may be a black rubber layer. It should be noted that the elastic light absorbing layer 34 in this embodiment is selected from the black rubber materials, and in the other embodiments may be superposition of the separate elastic layer and light absorbing layer, which is not limited by the present disclosure.

Particularly, the optical film 31 may be limited and fixed by the elastic light absorbing layer 34, and also may be adhered and fixed to the light-emitting surface 30b by means of a double-sided adhesive. The display panel may be provided within the groove of the light guide plate 30 by means of the elastic light absorbing layer 34, and also may be adhered and fixed to the elastic light absorbing layer 34, which is not limited in the present disclosure.

In one embodiment, as shown in FIG. 3B and FIG. 3C, the backlight module assembly 3 further includes an elastic light absorbing structure 35 arranged on the top end of the retaining wall 302.

Particularly, the elastic light absorbing structure 35 is arranged on the top end of the retaining wall 302. The elastic light absorbing structure 35 may absorb the light emitted from the top end of the retaining wall 302, to prevent the light from emitting out of the top of the light guide plate 30, so as to avoid appearance of the bright lines. At the same time, the elastic light absorbing structure 35 may be provided after the display panel and the frame are assembled, to avoid the display panel from directly contacting with the frame, and the elastic light absorbing structure 35 may take a buffering effect when the frame is applied by external force, to avoid appearing L0 light leakage.

In one embodiment, the elastic light absorbing structure 35 may be a black foam.

Optionally, the black foam is polyurethane foam with a compression ratio that may be 60% to 70%, for example, 70%. By setting the compression ratio of 70%, the black foam can play a certain buffering effect when the frame is applied by the external force, to avoid L0 light leakage. It should be noted that the elastic light absorbing layer 35 in the present embodiment is made of black foam material, and in other embodiments may be a superposition of the separate elastic layer and light absorbing layer, which is not limited in the present disclosure.

In one embodiment, the backlight module assembly 3 further includes a reflective sheet 36 arranged on a light guide surface 30c and the side wall of the light guide plate 30. The light guide surface 30c of the light guide plate 30 is a side surface of the plate body 301 opposite to the light-emitting surface 30b.

Particularly, the reflective sheet 36 is arranged on the light guide surface 30c and the sidewall of the light guide plate 30. The reflective sheet 36 may reflect the light emitted outwardly from the light guide plate 30 back to the light guide plate 30, to improve utilization of the light.

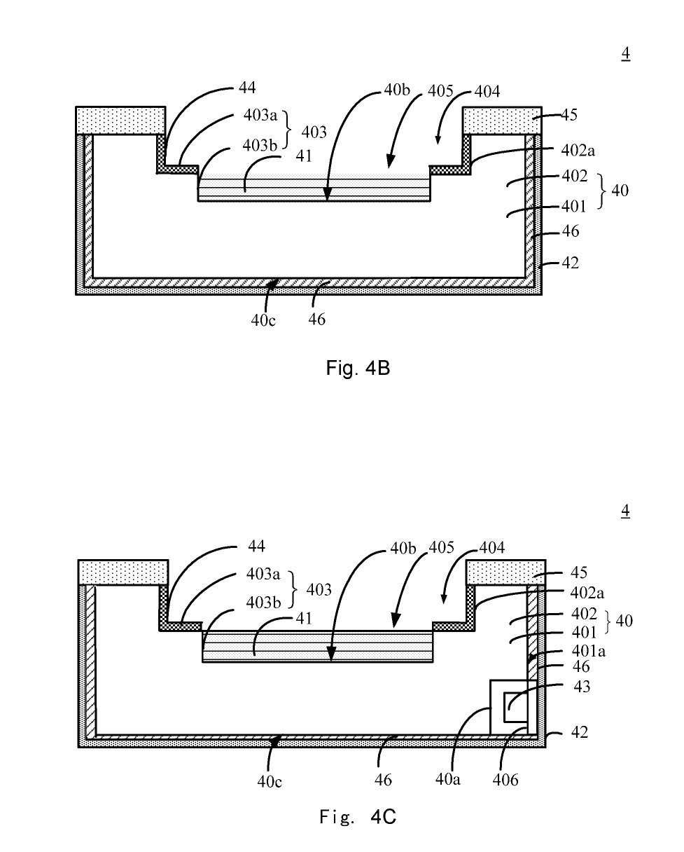

FIG. 4A is a structural schematic view of another backlight module assembly as provided in the embodiment of the present disclosure. FIG. 4B and FIG. 4C are a cross-sectional schematic view taken along a line A-A and a cross-sectional schematic view taken along a line B-B of the backlight module assembly as shown in FIG. 4A, respectively. As shown in FIG. 4A-FIG. 4C, backlight module assembly 4 includes a light guide plate 40, an optical film 41, a back plate 42 and a light-emitting unit 43. The light guide plate 40 has a light incidence surface 40a and a light-emitting surface 40b. The light guide plate 40 includes a plate body 401 and a retaining wall 402. One side surface of the plate body 401 is the light-emitting surface 40b of the light guide plate 40. The retaining wall 402 is arranged to protrude to the light-emitting surface 40b, and is the annular structure arranged along the edge of the plate body 401.

In one embodiment, a stepped part 403 extending from the light-emitting surface 40b is provided on the inner wall of the retaining wall 402. The stepped part 403 and the retaining wall 402 form a first groove 404 for receiving the display panel, and the stepped part 403 and the plate body 401 form a second groove for receiving the optical film 41.

The first groove for receiving the display panel and the second groove for receiving the optical film are formed by arranging the stepped part. The display panel and the optical film are respectively arranged in the two grooves to be fixed more stably, and thereby being used in a vehicle-mounted device that is in a harsh traveling environment and has a higher request for stability of the display panel. The display panel and the optical film may be fixedly supported by the light guide plate, such that the display panel can be mounted without using the plastic frame so as to avoid appearance of blue and white spots at the four corners of the display panel due to poor polarizer as a result that the plastic frame shrinks and presses the display panel at a low temperature. Meanwhile, design of no plastic frame reduces the production cost of the display device greatly.

Particularly, the stepped part 403 has a top surface 403a and a side surface 403b, wherein the top surface 403a of the stepped part and the inner wall 402a of the retaining wall 402 form the first groove 404 for receiving the display panel, and the side surface 403b of the stepped part and the plate body 401 form the second groove 25 for receiving the optical film.

Optionally, the plate body 401, the retaining wall 402 and the stepped part 403 are one-piece structure, and may be manufactured by an injection molding process. The light guide plate 40 may be made of organic materials, and also by using a glass light guide plate, which is not limited in the present disclosure.

In one embodiment, as shown in FIG. 4B, a light-emitting unit mounting slot 406 for receiving light-emitting unit 43 is provided on the side wall 401a of the plate body 401. The light-emitting unit mounting slot 406 is opened on the side wall 401a of the plate body 401, and the light-emitting unit 43 is arranged within the light-emitting unit mounting slot 406 to be embedded in the plate body 401, such that it is helpful to achieve a narrow frame.

It should be noted that as shown in FIG. 4B, the light-emitting unit mounting slot 406 is arranged on the side wall 401a of the plate body 401 of the light guide plate, herein light enters from the side wall 401a of the plate body 401 of the light guide plate. A light incidence mode of the display panel is a side-entered single-side light incidence mode, wherein the side-entered light incidence mode further includes a double-side light incidence mode, and both the single-side light incidence mode and the double-side light incidence mode may employ a long-edge light incidence or a short-edge light incidence. In other embodiments, the light-emitting unit mounting slot 406 may also be arranged according to the light incidence mode of the display panel, for example, the light-emitting unit mounting slot 406 may be arranged on the two side walls of the plate body 401 of the light guide plate when the light incidence mode of the display panel is the double-side light incidence. Furthermore, the light-emitting unit mounting slot 406 may be arranged on the side wall of the long edge of the plate body 401 of the light guide plate when the light incidence mode of the display panel is the long-edge light incidence. The light-emitting unit mounting slot 406 may be arranged on the side wall of the short edge of the plate body 401 of the light guide plate when the light incidence mode of the display panel is the short-edge light incidence. The present disclosure is not limited thereto. The light-emitting unit mounting slot 406 is opened on the side wall 401a of the plate body 401, and the light-emitting unit 43 is arranged within the light-emitting unit mounting slot 406 to be embedded in the plate body 401, such that it is helpful to achieve the narrow frame.

In one embodiment, as shown in FIG. 4A, one limiting slot 405a for fixing the optical film 41 is opened on the two side walls (i.e., the stepped part 403) opposite to each other of the second groove 405, and one lug structure fit to the limiting slot 405a is provided on the two side edges 41a opposite to each other of the optical film 41. In the other embodiments, according to the actual situations, a plurality of limiting slots 405a for fixing the optical film 41 are arranged on the two side walls opposite to each other of the second groove 405, and a plurality of lug structures fit to the limiting slots 405a are provided on the two side edges 41a opposite to each other of the optical film 41. The present disclosure does not limit thereto.

Particularly, in this embodiment, a limiting slot 405a and the lug structure fit to the limiting slot 405a are provided such that the optical film 41 can be fixed on the two side walls opposite to each other of the second groove 405, and also can take a function of preventing inversion.

In one embodiment, as shown in FIG. 4B and FIG. 4C, an elastic light absorbing layer 44 is also provided on the inner wall of the first groove 404.

Particularly, the inner wall of the first groove 404 includes the top surface 403a of the stepped part and the inner wall 402a of the retaining wall 402. An elastic light absorbing layer 44 is provided on the inner wall of the first groove 404 that is formed by the top surface 403a of the stepped part and the inner wall 402a of the retaining wall 402, and may be used to limit and fix the display panel and the optical film 41. And the elastic light absorbing layer 44 can prevent the display panel from directly contacting with the light guide plate 40 to be scratched, and thereby playing a buffering effect, and also absorb light to prevent the light from leaking from the periphery to result in bright lines on the display panel.

Optionally, elastic light absorbing layer 44 may be made of a black rubber.

It should be noted that the elastic light absorbing layer 44 in this embodiment is selected from the black rubber materials, and in the other embodiments may be superposition of the separate elastic layer and light absorbing layer, which is not limited by the present disclosure.

In one embodiment, as shown in FIGS. 4B and 4C, the backlight module assembly 4 further includes an elastic light absorbing structure 45 arranged on the top end of the retaining wall 402.

Particularly, the elastic light absorbing structure 45 is arranged on the top end of the retaining wall 402. The elastic light absorbing structure 45 may absorb the light emitted from the top end of the retaining wall 402, to prevent the light from emitting out of the top of the light guide plate 40, so as to avoid appearance of the bright lines. At the same time, the elastic light absorbing structure 45 may be provided after the display panel and the frame are assembled, to avoid the display panel from directly contacting with the frame, and the elastic light absorbing structure 45 may take a buffering effect when the frame is applied by external force, to avoid appearing L0 light leakage.

In one embodiment, the elastic light absorbing structure 45 may be a black foam.

Optionally, the black foam is polyurethane foam with a compression ratio that may be 60% to 70%, for example, 70%. By setting the compression ratio of 70%, the black foam can play a certain buffering effect when the frame is applied by the external force, to avoid L0 light leakage.

It should be noted that the elastic light absorbing layer 45 in the present embodiment is made of black foam material, and in other embodiments may be a superposition of the separate elastic layer and light absorbing layer, which is not limited in the present disclosure.

In one embodiment, the backlight module assembly 4 further includes a reflective sheet 46 arranged on a light guide surface 40c and the side wall of the light guide plate 40. The light guide surface 40c of the light guide plate 40 is a side surface of the plate body 401 opposite to the light-emitting surface 40b. The reflective sheet 46 is provided on the light guide surface 40c and the side wall of the light guide plate 40, and may reflect the light emitted outwardly from the light guide plate 40 back to the light guide plate 40, to improve utilization of the light.

It should be appreciated for those skilled in the art that illustration for the specific structure of the backlight module assembly can refer to the corresponding structure in the foregoing embodiments of the light guide plate for convenience and simplicity of the description, and thereby details will be omitted herein.

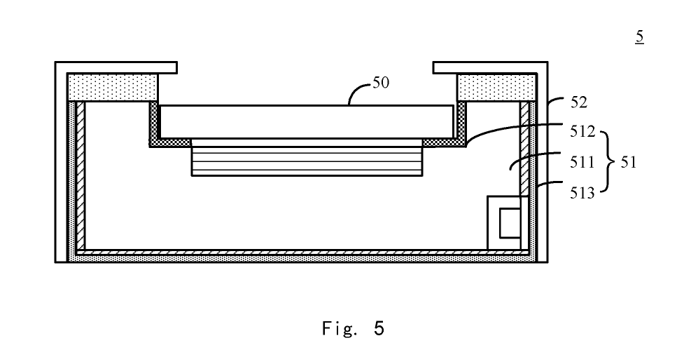

An embodiment of the present disclosure provides a liquid crystal display device, as shown in FIG. 5, including a display panel 50 and a backlight module assembly 51. The display panel 50 is arranged within the light guide plate 511 of the backlight module assembly 51.

Wherein, a display module assembly 51 may be the backlight module assembly as shown in FIG. 3A to FIG. 3C or the backlight module assembly as shown in FIG. 4A to FIG. 4C.

In the liquid crystal display device according to the embodiment of the present disclosure, a retaining wall presented in an annular structure is arranged on the light-emitting surface of the light guide plate. The retaining wall and the plate body form a groove for receiving the display panel and the optical film, thereby the display panel and the optical film can be fixedly supported by the light guide plate, such that the display panel can be mounted without using the plastic frame, so as to avoid poor polarizer as a result that the plastic frame shrinks and presses the display panel at a low temperature.

Particularly, the display panel may be provided within the groove of the light guide plate 511 by means of the elastic light absorbing layer 512 of the backlight module assembly 51, and also may be adhered and fixed to the elastic light absorbing layer 512, which is not limited in the present disclosure.

In one embodiment, as shown in FIG. 5, the liquid crystal display device further comprises: a frame 52 which is mounted on a back plate 513, and a display panel 50 is located between the frame 52 and the backlight module assembly 51.

In one embodiment, a gap between the frame 52 and the display panel 50 in a direction perpendicular to the display panel 50 may be 0.2 mm-0.3 mm. Size of the gap can solve the problem that the frame 52 presses the display panel 50 to make light leakage of the L0 serious when the gap between the frame 52 and the plastic frame is too small, and foreign substance arises between the frame 52 and the display panel 50 when the gap between the frame 52 and the plastic frame is too large.

In specific implementation, the liquid crystal display device provided in the embodiments of the present disclosure may be any product or component with a display function, such as a mobile phone, a tablet computer, a television, a display, a notebook computer, a digital photo frame, a navigator and the like.

It should be appreciated for those skilled in the art that illustration for the specific structure of the backlight module assembly can refer to the corresponding structure in the foregoing embodiments of the light guide plate for convenience and simplicity of the description, and thereby details will be omitted herein.

Although embodiments of the present disclosure were described above, these are just optional examples and do not limit the present disclosure. Any modification, equivalent substitution and improvement within the spirit and principle of the present disclosure will be construed as being included in the present disclosure.

1. A light guide plate, comprising:
a plate body having a light-emitting surface; and
a retaining wall, which is an annular structure arranged along an edge of the plate body, and protrudes to the light-emitting surface, wherein the plate body and the retaining wall together form a groove for receiving a display panel and an optical film.

2. The light guide plate according to claim 1, wherein an annular stepped part extends along an inner wall of the retaining wall from the light-emitting surface, the stepped part comprises a top surface and a side surface, the top surface and the retaining wall form a first groove for receiving the display panel, and the side surface and the plate body form a second groove for receiving the optical film.

3. The light guide plate according to claim 2, wherein, a limiting slot for fixing the optical film is opened on two side walls opposite to each other of the second groove respectively.

4. The light guide plate according to according to claim 1, wherein a light-emitting unit mounting slot for receiving a light-emitting unit is provided on a side wall of the plate body.

5. A backlight module assembly, comprising a light guide plate, an optical film, a back plate and a light-emitting unit, the light guide plate comprising a light incidence surface and a light-emitting surface, wherein
the light guide plate comprises a plate body and a retaining wall, one surface of the plate body is the light-emitting surface of the light guide plate, the retaining wall is an annular structure arranged on an edge of the plate body, and protrudes to the light-emitting surface;
the plate body and the retaining wall forms a groove for receiving a display panel and an optical film, and the optical film is provided within the groove and attached to the light-emitting surface;
the light guide plate and the light-emitting unit are both provided on the back plate, and the light-emitting unit is provided at the light incidence surface of the light guide plate.

6. The backlight module assembly according to claim 5, wherein an annular stepped part extends along an inner wall of the retaining wall from the light-emitting surface, the stepped part comprises a top surface and a side surface, the top surface and the retaining wall form a first groove for receiving the display panel, and the side surface and the plate body form a second groove for receiving the optical film.

7. The backlight module assembly according to claim 6, wherein a limiting slot for fixing the optical film is opened on two side walls opposite to each other of the second groove respectively, and a lug structure fit to the limiting slot is provided on a side edge of the optical film.

8. The backlight module assembly according to claim 6, wherein an elastic light absorbing layer is provided on an inner wall of the first groove.

9. The backlight module assembly according to claim 5, wherein a light-emitting unit mounting slot for receiving a light-emitting unit is provided on a side wall of the plate body, and the light-emitting unit is arranged within the light-emitting unit mounting slot.

10. The backlight module assembly according to claim 9, wherein it further comprises an elastic light absorbing structure arranged on a top end of the retaining wall.

11. The backlight module assembly according to claim 10, wherein the elastic light absorbing structure is a black foam.

12. The backlight module assembly according to claim 9 further comprising a reflective sheet arranged on the light guide surface and the side wall of the light guide plate, and the light guide surface of the light guide plate is a side surface of the plate body opposite to the light-emitting surface.

13. A liquid crystal display device, comprising:
a display panel; and
the backlight module assembly according to claim 5, the display panel being arranged within the groove of the light guide plate.

14. The liquid crystal display device according to claim 13, further comprising:
a frame mounted on the back plate, wherein the display panel is located between the frame and backlight module assembly.

15. The liquid crystal display device according to claim 14, wherein a gap between the frame and the display panel in a direction perpendicular to the display panel is 0.2 mm-0.3 mm.

16. The light guide plate according to according to claim 2, wherein a light-emitting unit mounting slot for receiving a light-emitting unit is provided on a side wall of the plate body.

17. The light guide plate according to according to claim 3, wherein a light-emitting unit mounting slot for receiving a light-emitting unit is provided on a side wall of the plate body.

18. The backlight module assembly according to claim 6, wherein a light-emitting unit mounting slot for receiving a light-emitting unit is provided on a side wall of the plate body, and the light-emitting unit is arranged within the light-emitting unit mounting slot.

19. The backlight module assembly according to claim 7, wherein a light-emitting unit mounting slot for receiving a light-emitting unit is provided on a side wall of the plate body, and the light-emitting unit is arranged within the light-emitting unit mounting slot.

20. The backlight module assembly according to claim 8, wherein a light-emitting unit mounting slot for receiving a light-emitting unit is provided on a side wall of the plate body, and the light-emitting unit is arranged within the light-emitting unit mounting slot.
